(19) United States
(12) Patent Application Publication
(10) Pub. No.: US 2007/0107770 A1
(43) Pub. Date: May 17, 2007

(54) Systems and methods for manufacturing photovoltaic devices

(76) Inventor: Tom Rust, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/580,718

(22) Filed: Oct. 12, 2006

Related U.S. Application Data
(60) Provisional application No. 60/726,520, filed on Oct. 13, 2005.

(51) Int. Cl. H02N 6/00

(52) U.S. Cl. 136/246

(57) ABSTRACT

A solar energy system can include at least one holographic optical element to encode the focusing of solar radiation. Multiple holograms and/or multiple layers can be used to focus light over a band(s) of angles and/or wavelengths onto an array of solar cell elements. The selection of holograms in a concentrator can allow a photovoltaic device to receive light over a wide range of incident angles, and can allow for the receiving of a wide band of wavelengths without inoperable gaps in angle of incidence or wavelength. This range of incident angles for solar cells allows the solar cells to receive light over a large period of daylight without the need to mechanically rotate or pivot the device in order to track the movement of the sun throughout the daylight period.

### PRIORITY CLAIM

This application claims priority to U.S. Provisional Patent Application No. 60/726,520, filed Oct. 13, 2005, which is hereby incorporated herein by reference.

### BACKGROUND OF THE INVENTION

The present invention relates to solar photovoltaic devices and methods for producing those devices.

A photovoltaic device is a semiconductor device useful for converting solar radiation into electrical energy. Solar photovoltaic systems to this point have not been used extensively in power supplying applications due primarily to the high cost of these systems. The high cost is due in part to the pure single crystal silicon that typically is used in these devices. Further, photovoltaic processing itself is not particularly cost effective for many applications. Solar radiation concentration systems also can be very large, which is undesirable for applications such as home installation.

Yet another problem with existing solar devices is the need for these devices to actively “track” the sun, or mechanically rotate or pivot about an axis in order to point the device substantially in the direction of the sun. This tracking is needed to obtain sufficient radiation levels throughout the course of the day. A lens or other light-concentrating element 102 can be used to focus light from the sun onto a solar cell 104, as shown in the configuration 100 of FIG. 1. This works well while the incoming light is substantially orthogonal to the plane of the concentrating element 102, but once the light is substantially off-axis the light is no longer concentrated onto the solar cell 104. As such, it is necessary to rotate the solar device so that the plane of the concentrating element is substantially orthogonal to the incoming solar radiation. The mechanical components necessary to drive the tracking of the device increase the cost and complexity of manufacturing, include moving parts that have long term maintenance issues and increase the probability of device failure, and require excessive space in depth. Without a mechanical tracking system, however, the range of solar angles that can be accepted without a mechanical tracking system is limited.

### BRIEF SUMMARY OF THE INVENTION

Systems and methods in accordance with various embodiments of the present invention provide for the concentration of radiation of various wavelengths and over large regions of incident angle for photovoltaic devices. Such concentration can provide passive tracking of the sun for solar devices, and can allow for the concentration of light without substantial gaps in wavelength or incident angle.

In one embodiment, a concentrator for a solar device includes a primary hologram formed into a refractive element. The primary hologram is able to focus light onto at least one photovoltaic cell of the solar device. In some embodiments, at least one complimentary hologram is formed into the refractive element, such as into a common region of the refractive element. In other embodiments, a primary hologram is formed into a first layer of the refractive element, with any complimentary holograms being formed into at least a second layer of the refractive element. Each complimentary hologram can be used to focus at least some wavelengths of light not focused by the primary hologram, and/or can focus light for at least some incident angles not focused by the primary hologram.

Each hologram can be a volume hologram or a phase hologram, for example. The holograms also can each include a series of grooves formed in the refractive element. The primary hologram and complimentary hologram(s) together can provide passive tracking of the sun throughout at least a period of daylight, and/or over a range of incident angles of about +/−45 degrees. The primary hologram and complimentary hologram(s) also can be selected to not cause destructive interference of light redirected thereby.

The primary hologram and any complimentary holograms can focus incoming light along columns of photovoltaic cells. A reflective backing also can be used to reflect light back through a photovoltaic cell.

In one embodiment, a concentrator includes a first hologram layer including a first plurality of holograms operable to focus a first set of bands of incident light onto at least one photovoltaic cell. The concentrator also includes a second hologram layer including a second plurality of holograms operable to focus a second set of bands of incident light onto the at least one photovoltaic cell. The first and second bands may or may not overlap.

In another embodiment, a photovoltaic includes at least one photovoltaic cell and a refractive element including a primary hologram formed therein. The primary hologram is operable to focus solar radiation onto the at least one photovoltaic cell. The refractive element also can include includes at least one complimentary hologram.

Other embodiments will be obvious to one of ordinary skill in the art in light of the description and figures contained herein.

### BRIEF DESCRIPTION OF THE DRAWINGS

Various embodiments in accordance with the present invention will be described with reference to the drawings, in which:

FIG. 1 shows a concentrating element focusing sunlight onto a solar cell of the prior art;

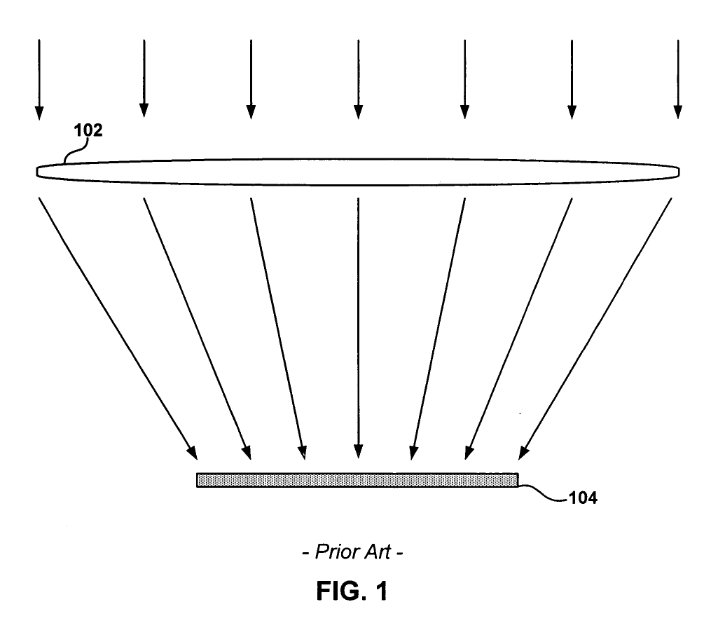

FIG. 2 shows a holographic concentrator, with light entering at 0° relative to the normal of the surface, concentrating the light towards the surface of an energy conversion element in accordance with one embodiment of the present invention;

FIG. 3 shows a holographic concentrator, with light entering at an offset angle relative to the normal of the surface, concentrating the light towards the surface of an energy conversion element in accordance with one embodiment of the present invention;

FIG. 4 shows a cross-section of an exemplary holographic grating that can be used with the holographic concentrator of FIGS. 2-3;

FIG. 5 shows rays passing through “holes” in a holographic grating in accordance with one embodiment of the present invention;

FIG. 6 shows multiple layers of holographic gratings in accordance with one embodiment of the present invention;

FIG. 7 shows a holographic grating focusing light at different angles into columns in accordance with one embodiment of the present invention;

FIG. 8 shows an example array of 4×4 of photovoltaic cells with interconnection in accordance with one embodiment of the present invention;

FIG. 9 shows a set of four columns of cells with interconnect wiring in between columns in accordance with one embodiment of the present invention; and

FIG. 10 shows a holographic grating focusing light at different wavelengths into columns in accordance with one embodiment of the present invention.

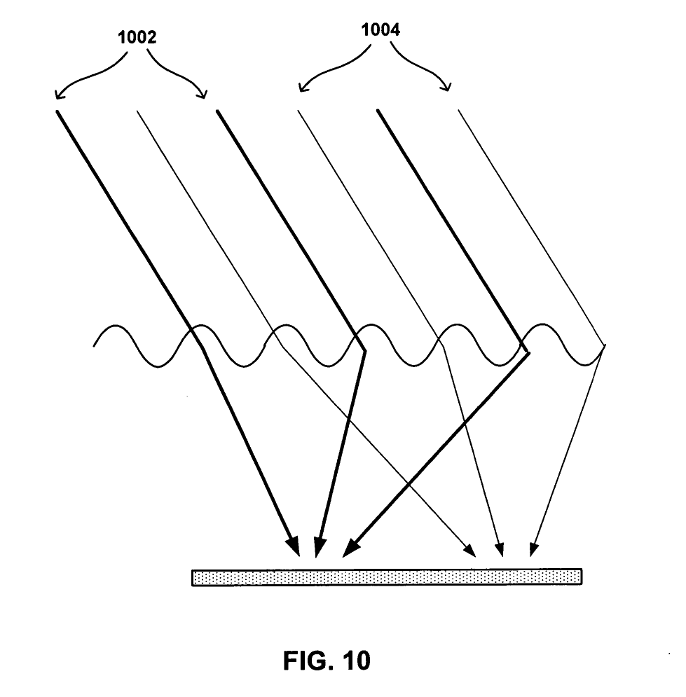

### DETAILED DESCRIPTION OF THE INVENTION

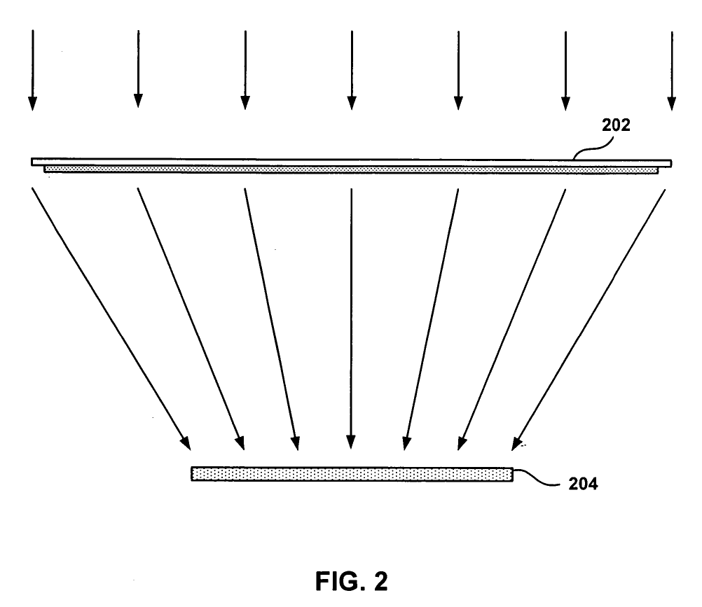

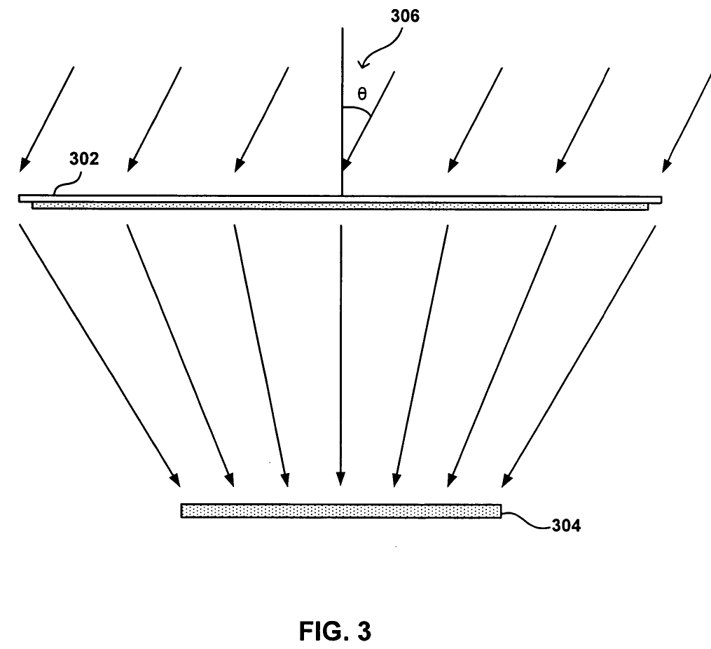

Systems and methods in accordance with various embodiments of the present invention can overcome the aforementioned and other deficiencies in existing photovoltaic systems and devices by changing the way in which light is collected and directed toward the photovoltaic elements. In one embodiment, a hologram-based concentrator 202 is used to focus incoming solar radiation onto a photovoltaic element 204 as shown in the configuration 200 of FIG. 2. In order to also provide for passive tracking, multiple holographic functions can be encoded into a single hologram, multiple holograms, or a set of stacked hologram layers, in a low cost refractive media. Multiple holograms can be selected to concentrate solar radiation onto an array of solar cells over a range of travel of the sun. As shown in the arrangement 300 of FIG. 3, a hologram-based concentrator 302 can focus incoming radiation onto a photovoltaic device 304 even when the incoming radiation is at an angle θ relative to a normal of the surface of the concentrator.

There are several different types of holograms that can be used to focus radiation in accordance with various embodiments. One such type is a volume hologram, which typically is formed of a material such as a dichromated gelatin (DCG). Volume holograms include regions embedded within a material that have differing refractive indices, which can be modified by exposure to fringes of laser light. For example, interference patterns can interact with the dichromate to cause changes in the index of refraction within the volume of the dichromated gelatin. There typically is no change to the surface of the material. The changes in refractive index can produce fringes that are angled within the structure. Through proper encoding of the hologram, a lens function can be generated that focuses the light passing through the hologram and exiting the concentrator structure. There can be disadvantages to using dichromated gelatin holograms, however, as these holograms can be more difficult to copy than other holograms. Further, these holograms tend to be expensive and the material itself can be subject to degradation with exposure to ultraviolet (UV) radiation. A UV filter can be placed in front of the hologram to reduce the exposure to UV, allowing a DCG-style hologram to be used as a concentrator. This solution still might not be optimal, however, due to factors such as the replication difficulty and cost.

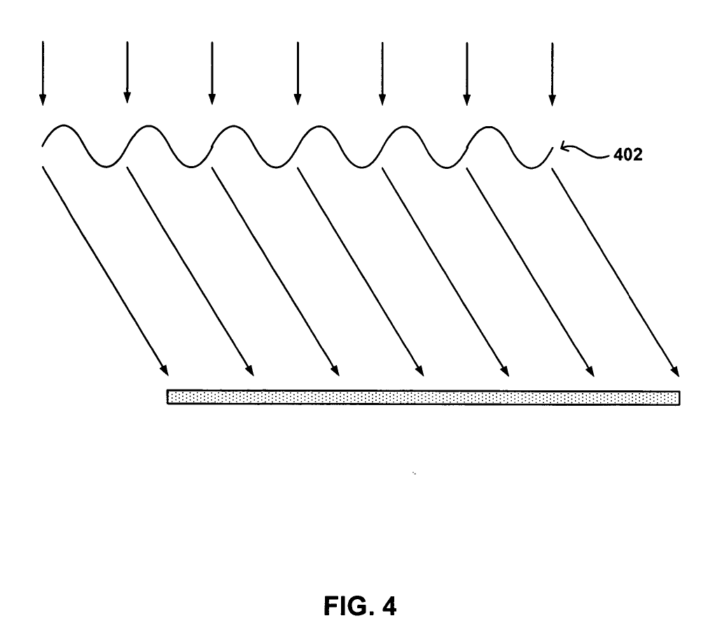

A system in accordance with various embodiments provides a solution that can be preferred for many applications utilizing a phase hologram in a concentrator structure. A phase hologram typically takes the form of a series of grooves formed in a refractive medium. An example of a series of grooves 402, or grating structure, acting as a phase hologram is shown in the cross-section of the arrangement 400 of FIG. 4. The grooves here are shown for illustrative purposes as a simple sine wave, exaggerated in dimension, but it should be understood that any of a number of groove configurations can be used as would be understood to one of ordinary skill in the art. The grating can be stamped or otherwise formed into a refractive material using various techniques known in the art. The period of each grating can be on the order of the wavelength of the incoming light. Where the incoming light contains a wide range of wavelengths, a number of gratings can be used to capture a desired range of wavelengths. The hologram also can have beveled edges, similar to a Fresnel lens as known in the art.

Light passing through the grooves 402 can undergo a change in velocity, which effectively changes the phase relationship of wavefronts entering the medium. Altering the phase relation of the wavefronts causes refraction at an angle determined by factors such as wavelength, angle of incidence, groove spacing and amplitude, and the refractive index of the medium. The grooves, or other changes in surface topology, can be generated to correspond to a desired fringe structure. In one example, a resist can be deposited on a glass plate then exposed to a holographic pattern using object and reference beams as known in the art for producing holograms. Once the resist is developed there is a corresponding topological change in the resist, comprising the holographic function. As light passes through the undulating surface comprising the hologram, the changes in speed and phase of the light can change the direction of the light passing through the concentrator structure, effectively producing a lens function that is very similar to that of the DCG-style hologram described above. The phase hologram, however, can be much easier and cheaper to produce, and can offer less degradation over time upon exposure to radiation.

In one embodiment, a holographic concentrator consists of a refractive material such as plastic or glass. A holographic pattern is stamped, embossed, or otherwise formed into one or more layers of the refractive material. The holographic function itself can consist of one or more multiple holographic patterns. The patterns can be encoded into one or more layers, regions, and/or surfaces of the refractive material, as described below. In one embodiment, each pattern encodes the function of a convex lens, such that incoming light is focused down to a point, line, rectangle, or other similar shape or spot, with at least one dimension being smaller than the holographic element. By focusing the light to such shapes, an array of individual concentrator elements can be used wherein each element directs light to an array of energy conversion elements, such as silicon photovoltaic cells. Alternatively, multiple holographic patterns can be used to focus incoming light on a subset of possible solar cell locations, such that fewer solar cells can be used and the cost of the photovoltaic device can be decreased.

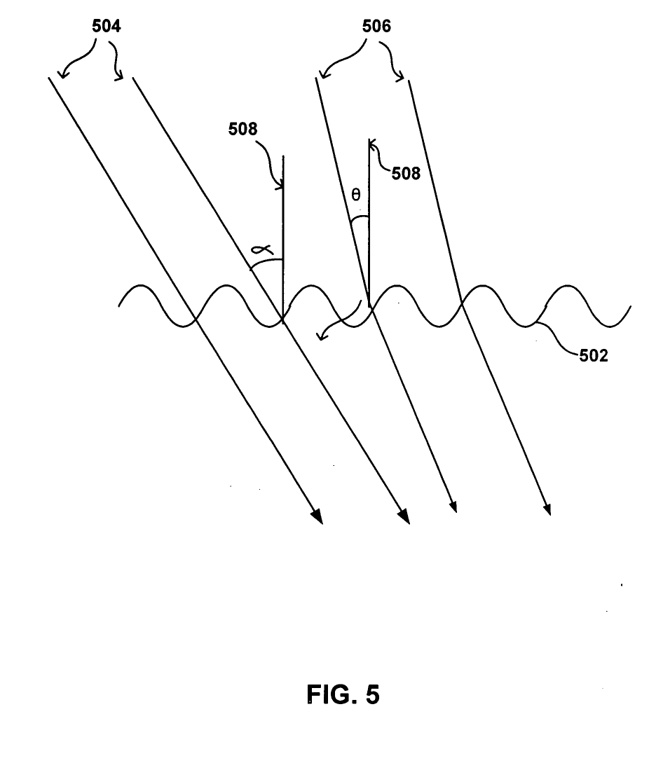

For each holographic pattern, there can be a corresponding output function that causes light entering at a particular angle, or within a particular angular range, to focus onto an energy conversion element. Over some range of input angles, such as angled over a 10° spread (+/−5°), the hologram can efficiently focus the incoming light onto the energy conversion element. Outside that range, that particular pattern can have little or no effect on the incoming light. For instance, the arrangement 500 of FIG. 5 shows a first pair of rays 504 that are at an angle α with respect to a normal 508 to the surface of the hologram concentrator 502. Since α is outside the angular range of the hologram, the rays simply pass through without being redirected by the concentrator. In contrast, a second pair of rays 506 is at an angle θ with respect to a normal 508 to the surface of the hologram concentrator. Since θ is within the angular range of the hologram, the rays are redirected and focused by the concentrator.

In order to focus light over a wider range of incoming light angles, additional holograms can be encoded into the surface of the refractive medium. Holograms can be combined as known in the art, similar to adding together waves of differing frequencies to form a complex wave function. For example, the grating in FIG. 4 is shown as a single phase hologram, but there can be multiple grating shapes summed into a grating profile. For example, a layer might have a shape that would result from adding together six sine waves of different frequency. It has been found that for certain embodiments the efficiency of a multiple hologram concentrator is actually greater than that of single holograms for a number of angular positions.

While it would seem that an entire angular range could be captured simply by using a sufficient number of hologram patterns, it was found that simply increasing the number of hologram patterns in a layer, and thereby decreasing the angular spacing, can cause destructive interference of the light from different angles. This interference can render the device inoperable. In order to encode multiple holograms such that the holograms each provide the described focusing function, care should be taken to ensure that the diffraction angles of each of the patterns do not destructively interfere with each other. For practical applications which require high efficiency, the input angles of each holographic pattern encoded into a material can require a certain minimum spacing. The minimum spacing can vary with angle. In one embodiment, it was found that a maximum of five or six holograms could be successfully encoded into a layer without (or with minimum) interference between the holograms. The number of holograms for different embodiments can vary, due to factors such as the wavelength of light used and the periods of the holograms. By encoding at most this number of holograms, a concentrator can effectively focus light over the ranges for each individual hologram.

The angular range is important for many applications because, over the course of the day as the sun moves across the sky, there is a limited angular motion over which any one particular hologram will be functional. Experimentally, it has been seen that at least some holograms are only functional between about +/−5° to +/−10° of variation. Outside of this functional range, light simply passes through the hologram without being redirected. As light begins to enter this range, some of the light will begin to be diffracted by the hologram. There will be some angular range within the functional range where a maximum efficiency is obtained. As the light nears the other end of the range, the efficiency can again taper off. By encoding multiple holograms, such as by using multiple exposures, then encoding these multiple holograms into the material, a number of bands can be obtained comprising encoded positions, or ranges of angles where at least one of the multiple holograms is functional. Light outside of these encoded ranges will essentially pass through the patterns. Within these ranges light will be refracted and focused down onto the solar cells.

A potential problem with combining multiple holograms into a single surface layer in this way comes in the fact that the combined holograms can result in “holes” or “gaps” in the range of operable angles of sunlight relative to the concentrator. Holes, as they are called herein, refer to regions bounded by certain ranges of input angles in which that particular layer essentially has little or no effect. Light entering in one of these input angle ranges will pass directly through the hologram, without being focused or concentrated onto the underlying solar cells. These holes can lead to variations in the amount of light focused throughout the course of a day

One way to address this problem is to utilize at least one additional layer of multiple holographic functions. To compensate for holes, as well as to cover a large angular range, multiple layers of holograms can be used. In some embodiments two layers may be sufficient, while other embodiments may require three or more. A second hologram layer, which can be positioned under the first or “top” hologram layer, can encode angles that are not encoded by the first hologram layer. Light that passes through the holes in the top hologram layer can be focused by a second (or subsequent) layer down onto the solar cells. If additional layers are used, light passing through holes in the first two layers can be encoded by one of these additional layers.

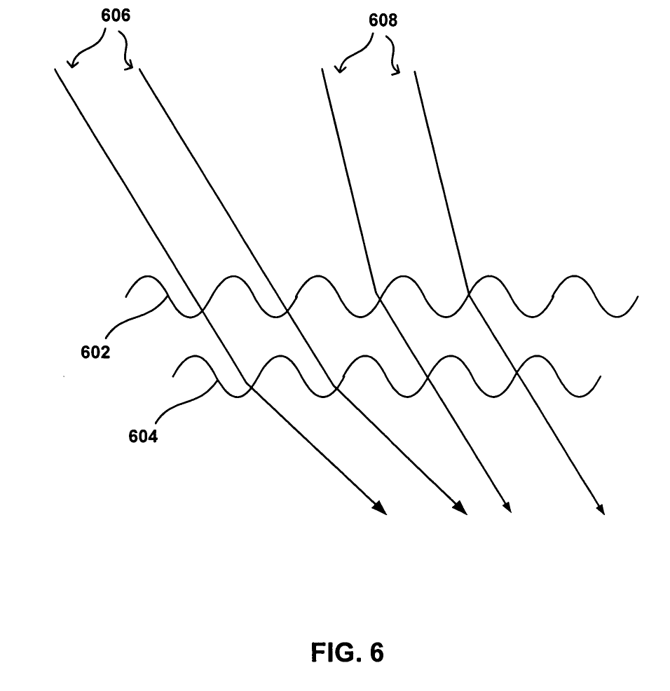

Use of multiple layers is shown, for example, in the arrangement 600 of FIG. 6. As can be seen in the Figure, a pair of rays 606 coming in at a first angle is passed directly through the first hologram layer 602, through a “hole” in the upper layer. These rays are incident upon a second hologram layer 604 at the same angle, but are redirected by the second layer. A second pair of rays 608 is incident upon the first hologram layer 602 at a second angle, and is redirected by the first hologram layer. These redirected rays then pass directly through the second hologram layer 604. The holograms in the first and second layers can be selected such that the holograms in the second layer redirect rays for the holes in the first layer, and vice versa, such that substantially all angles over a given overall angular range are directed by (at least) one of the hologram layers. It can be undesirable to have the ranges of the hologram layers overlap in some embodiments, while other embodiments might utilize the additional focusing ability. In one such device, multiple holographic functions are separately encoded in the top and bottom surfaces of a refractive medium.

There can be an issue with interaction from the “top” hologram and a second hologram layer “underneath.” Normally, light is always focused in the same way, in that light of the appropriate angular range, being focused by the top or a subsequent hologram layer, almost always follows the same path exiting that hologram layer, except for very small angular changes through a second or subsequent hologram layer. It then is normally necessary in this embodiment for the second or subsequent holograms to simply pass through the focused rays that have passed through from the top or previous hologram layers. Multiple layers can be used to cover the range of tracking angles chosen to be encoded into the holograms. For practical purposes, there may be no point to encoding angles greater than +/−45°. At larger angles the sun may be so far off-axis that the amount of capturable light that would produce useful power might be so low as to not be useful. As such, a range can be defined over which one may choose to define the optimal set of holograms to encode light. This range can balance the capturable light at farther off-axis angles with the cost for configuring hologram layers to capture those angles.

In one example, a concentrator can utilize three stacked gratings, a top grating, a middle grating, and a bottom grating, although it should be understood that designations such as top and bottom are used for simplicity of understanding and explanation and should not be read as required orientations or limitations on the embodiments described herein. In this example the top grating, or the grating upon which incident radiation first impinges, is selected to redirect light incident at an angle of −50°±10° and +10°±10°, in order to cover a range of −60° to −40° and 0° to +20° relative to normal. The middle grating is selected to redirect light incident at an angle of −30°±10° and +30°±10°, in order to cover a range of −40° to −20° and +20° to +40° relative to normal. The bottom grating is selected to redirect light incident at an angle of −10°±10° and +50°±10°, in order to cover a range of −20° to 0° and +40° to +60° relative to normal. The total effective range of the concentrator is then approximately −60° to +60° relative to normal.

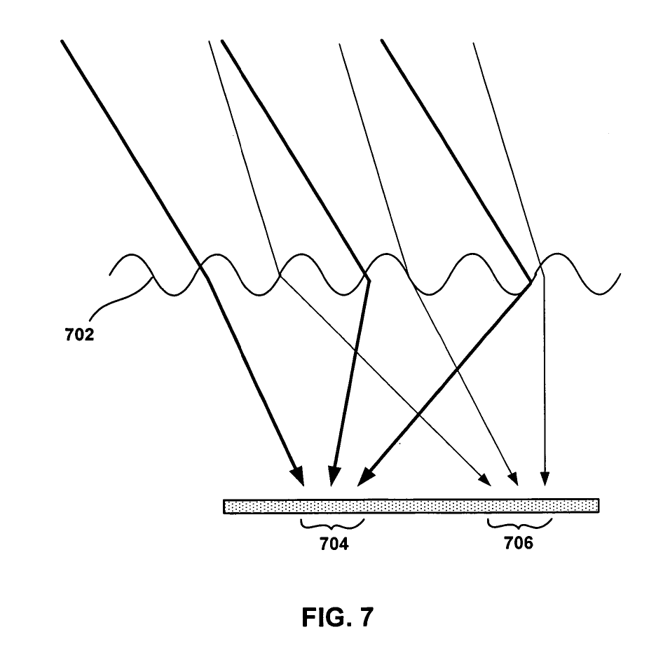

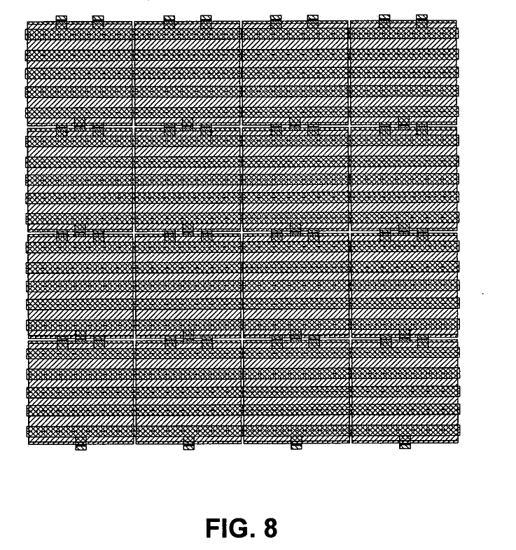

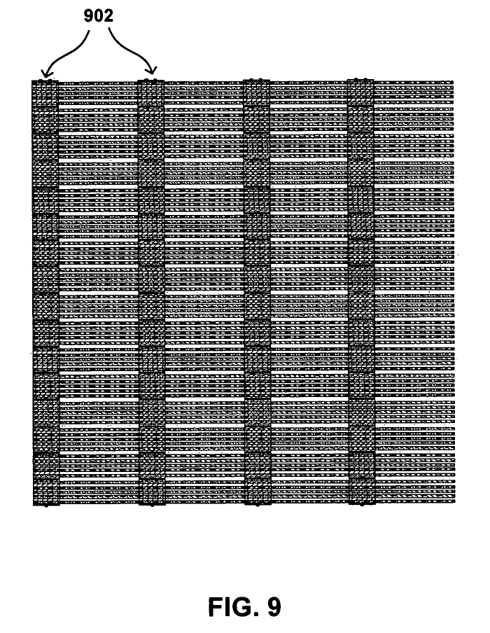

Multiple sets of patterns can be designed to complement each other to effectively eliminate holes as discussed above. Another advantage to using multiple sets of patterns is the ability for each hologram to focus light over the effective range to a specific location. For example, as shown in the arrangement 700 of FIG. 7 (and greatly exaggerated for illustrative purposes), the concentrator 702, which can include multiple layers and/or multiple holograms, can be designed such that light incident at different angles is focused (via different holograms) to different locations 704, 706. The ability to selectively focus light allows solar devices to be used without a continuous region of solar conversion elements. For example, a solar device might include a tightly-packed array of solar cells 800, such as is shown in the arrangement of FIG. 8 and described in U.S. patent application Ser. No. 11/525,562, filed Sep. 21, 2006, [ATTY DOCKET NO. 026238-000110US], which is hereby incorporated herein by reference. The ability to selectively focus light allows the solar cells to be formed into columns 902, such as is shown in the arrangement 900 of FIG. 9 and also described in the cited application, whereby all incoming light can be focused onto one of these columns depending upon the incident angle and hologram redirecting the light. Using columns of cells, instead of tightly-packed arrays, can greatly decrease the cost of the device.

The holographic patterns also can be formed in a refractive medium using grooves that are wavelength-specific. An advantage to wavelength-specific holograms is that light of different wavelengths can be selectively directed via the different holograms. For example, with an angle of incidence θ for incoming light (relative to normal), light of different wavelengths 1002, 1004 can focus to different positions along the axis between the hologram and focus point. Again, the figure is exaggerated for illustration. With light entering at input angles other than 0°, the focus point of different wavelengths can be spread laterally across the energy conversion element. Care can be taken in the design of the hologram patterns, and the spacing of the conversion elements, such that the bulk of the desired wavelengths of light converge on the energy conversion elements over the desired range of input angles.

Different wavelengths of light can spread laterally over the solar cells underneath. The spectral spreading can have practical aspects in terms of how high a concentration factor can be implemented. There also can be ramifications in terms of the spacing between the hologram(s) and the solar cell. In general, increasing the spacing can help spectral spreading, but can be a disadvantage as keeping the hologram as close as possible to the solar cells requires less filler material. An advantage of a “squiver” device such as that shown in FIGS. 8 and 9 and described in U.S. patent application Ser. No. 11/525,562, filed Sep. 21, 2006, [ATTY DOCKET NO. 026238-000110US], is that the squivers can be relatively small, and can be aligned in columns that are relatively small, such that there can be relatively small spacings between the holograms and the squivers. This spectral splitting also can be used to an advantage, as solar cells can be used that have increased efficiency for certain wavelengths. For example, some cells might be more infrared (IR) sensitive, and produce higher output at IR wavelengths, while some might be more efficient for visible wavelengths. The holograms can be encoded with the ability to preferentially focus light for one strip of solar cells that use one band (visible) of light, and for an adjacent strip of cells that is more efficient for converting another spectral band (IR). This can be done through encoding the holograms to diffract the light preferentially into the desired bands.

In an alternate embodiment, a holographic pattern can be encoded with multiple patterns that separate bands of wavelengths. For example, each of a number of different bands of wavelength can converge on a separate energy conversion element. These separate conversion elements each can be tuned to provide maximum conversion efficiency for a particular band of wavelengths. Since most energy conversion materials exhibit maximum conversion efficiency over only a certain range of wavelengths, this technique can be used to maximize the conversion of all available wavelengths of incoming illumination. Each of the multiple conversion elements can be tuned to maximize specific bands of light. The holographic patterns can be designed to direct these separate bands to the separate elements.

Using multiple holograms with columns of cells allows the sunlight to be pointed onto the columns as the earth rotates, providing one-dimensional passive tracking as described above. This one-dimensional tracking can be sufficient, as the seasonal variations in sun position relative to the columns results in an “up and down” movement of the light focused by the lens structures. If the solar cells are arranged in columns having a longitudinal axis that is substantially aligned with this “up and down” direction, the elongated spot of light focused onto each column will simply move along that longitudinal axis, such that substantially the same amount of light is focused over the majority of the columns. There can be slight variations in the amount of light focused at the ends of the columns, but the amount of overall variation in light intensity focused on the cells can be minimal. A simple way to take advantage of all the light is to have the light spot generated by each cylindrical lens be of a length less than the length of the respective column, such that as the spot moves up and down along the column, the ends of the spot never goes outside the column of cells. A determination can be made as to whether the additional size and cost of the longer columns of cells is offset by the benefit of the additional light energy captured by these longer columns.

There can always be some inefficiency in such a device. There can be losses from front and back surfaces of each hologram, as well as transmission efficiencies for light passing through the holograms. Typical holograms are capable of 70-80% transmission efficiencies, with 70-80% of the incoming light being diffracted down to the solar cells or target surface. While some losses are inherent in a structure such as this, an advantage is that the assembly process is very inexpensive. In one exemplary process, where the acrylic/plastic has to be stamped anyway, the top hologram layer can be obtained without additional process steps simply by placing the stamp for the hologram on one side of the stamper used for the acrylic/plastic. In the case of plastic, where there can be a cover surface anyway, the other hologram can be stamped into that glass, or another thin piece of plastic applied over that glass. The ultimate advantage is that the major cost in the modules is the processing and the silicon in the solar cells themselves. The cost of the plastic or the cover glass is much lower than this cost, although at some point it can become comparable. Somewhere in the range of 2X-4X, there can be an advantage to using a concentrator and a smaller number of cells, and getting the cost of the overall module significantly lower. For the same area, the power output may not be as great due to the efficiency losses, but it might be 70-80% as efficient. This still is a reasonably good efficiency for a system, and if the cost is reduced by 2X-4X, it is obviously a significant improvement in cost. The cost per Watt is probably the dominating factor for many of these devices, and one of the desires for solar energy, so this provides a major advantage.

In a production environment, it can be too expensive and inefficient to form each hologram individually. Once a desired topology is determined and created for a first device, a mold can be made of that topology, such as may be encoded into a resist layer as described elsewhere herein. Material can be deposited onto the resist that will build up a metal layer, such as a layer of nickel, which will form a “daughter” stamper as known in the art. From the daughter stamper, a “master” stamper can be created that will be used to actually stamp the hologram pattern into the plastic, glass, or other refractive material being used. Such a process can be tricky for reasons such as thermal expansion. The stamper can expand if formed from plastic or acrylic, but at different rates, and will not expand as much if formed from a material such as glass as if formed from nickel or plastic. There then can be compensation made for thermal expansion effects in the selected material.

In many embodiments, each hologram is substantially parallel to the solar cell(s). In other embodiments, the cells can be at a right angle to the hologram, such that the light would be focused onto the cells at right angles. Such cells could fall or flow into slots, such as vertically oriented slots in a piece of glass or plastic. The light then can be focused onto those slots. Other embodiments, structures, and arrangements can be used without departing from the teachings herein.

In almost every embodiment there will be a situation, particularly for IR wavelengths, where light will pass all the way through the cells. As a consequence the back of the cell (and anything beyond the cell) can have important properties. There can be an advantage to directly placing a metal, such as a metal interconnect, or other reflective material on the backside of the cell, as that material/metal can substantially reflect all light impinging thereon. The reflected light can travel back through the cell, giving the photons a second opportunity to interact with the solar cells and be converted to energy.

If there is a Mylar® or similar backing (Mylar® is a registered trademark of DuPont of Des Moines, Iowa), an insulating backing behind the cell, or a gap and then a backing material, which can have a metal interconnect or contact layer behind that, there is an additional opportunity for interaction, which can cause reflection losses and interactions with both the surface of the material and the inner material. Such a material can degrade due to UV exposure, although the material may not be subjected to much UV as much of the radiation will be blocked by the cell. Because of issues such as these, many embodiments do not use such backings. If a backing is used, other than a material contact or interconnect, it can be desired to utilize a sufficiently reflective backing. There may, however, be some advantage to a backing being diffuse, instead of simply reflecting light back directly through the cell. There can be an advantage to reflecting light at oblique angles, as that would give more opportunity for the photons to interact with the cell and convert more light energy. In order to get the reflective and diffuse characteristics, an interconnect can be used that is reflective and tends to have a matte finish, rather than a smooth surface.

The holograms can be selected and combined using any combination of experimentation, mathematics, and modeling as known in the art. The holograms can be selected based on any of a number of factors, such as desired wavelength ranges, bands, and efficiencies.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A concentrator for a solar device, comprising:
a primary hologram formed into a refractive element, the primary hologram operable to focus light onto at least one photovoltaic cell of the solar device.

2. A concentrator according to claim 1, further comprising:
at least one complimentary hologram formed into the refractive element.

3. A concentrator according to claim 2, wherein:
the at least one complimentary hologram is formed with the primary hologram into a common region of the refractive element.

4. A concentrator according to claim 1, wherein:
the primary hologram is formed into a first layer of the refractive element, and at least one complimentary hologram is formed into a second layer of the refractive element.

5. A concentrator according to claim 4, wherein:
the at least one complimentary hologram is operable to focus at least some wavelengths of light not focused by the primary hologram.

6. A concentrator according to claim 4, wherein:
the at least one complimentary hologram is operable to focus light for at least some incident angles not focused by the primary hologram.

7. A concentrator according to claim 1, wherein:
the primary hologram is one of a volume hologram and a phase hologram.

8. A concentrator according to claim 2, wherein:
the primary hologram and each complimentary hologram together provide passive tracking of the sun throughout at least a period of daylight.

9. A concentrator according to claim 8, wherein:
the passive tracking occurs over a range of about +/−45 degrees.

10. A concentrator according to claim 1, wherein:
the primary hologram includes a series of grooves formed in the refractive element.

11. A concentrator according to claim 2, wherein:
the primary hologram and each complimentary hologram do not cause destructive interference of light redirected thereby.

12. A concentrator according to claim 2, wherein:
the primary hologram and each complimentary hologram together focus incoming light along columns of photovoltaic cells.

13. A concentrator according to claim 1, further comprising:
a reflective backing operable to reflect light passing through the photovoltaic cell back through the photovoltaic cell.

14. A concentrator for a solar device, comprising:
a first hologram layer including a first plurality of holograms operable to focus a first set of bands of incident light onto at least one photovoltaic cell; and
a second hologram layer including a second plurality of holograms operable to focus a second set of bands of incident light onto the at least one photovoltaic cell.

15. A concentrator according to claim 14, wherein:
the first and second bands do not overlap.

16. A solar device, comprising:
at least one photovoltaic cell; and
a refractive element including a primary hologram formed therein, the primary hologram operable to focus solar radiation onto the at least one photovoltaic cell.

17. A device according to claim 16, wherein:
the refractive element further includes at least one complimentary hologram.
